(19) United States
(12) Patent Application Publication
(10) Pub. No.: US 2018/0062863 A1
(43) Pub. Date: Mar. 1, 2018

(54) METHOD AND SYSTEM FOR FACILITATING AUTHENTICATION

(71) Applicant: 18 DEGREES LAB PTE. LTD., Singapore (SG)

(72) Inventors: Krishnamoorthy BASKARAN, Singapore (SG); Sivanesan Kailash PRABHU, Singapore (SG)

(21) Appl. No.: 15/557,596

(22) PCT Filed: May 11, 2016
(86) PCT No.: PCT/SG2016/000004

§ 371 Date: Sep. 12, 2017

(30) Foreign Application Priority Data
Mar. 12, 2015 (SG) 10201501929R
Mar. 12, 2015 (SG) 10201601937T

(51) Int. Cl. H04L 9/32; H04L 9/30; H04L 29/06

(52) U.S. Cl. CPC H04L 9/3271; H04L 9/30; H04L 63/10; H04L 63/067; H04L 63/0838

(57) ABSTRACT

A method and system for facilitating authentication of a user for a network transaction. The method includes receiving a request for a transaction over a first communication channel. Further, the method includes transmitting a challenge to a user device associated with the request over a second communication channel disparate from the first communication channel. Additionally, the method includes receiving a response from the user device comprising an encrypted version of the challenge. The encrypted version is obtained by encrypting the challenge based on a public key. The public key is obtained by decrypting an entity secret stored in the user device based on a passcode provided by the user. Further, the method includes decrypting the response based on a private key corresponding to the public key to obtain a result. Moreover, the method includes authenticating the user device based on detection of the challenge comprised in the result.

### FIELD

The present disclosure generally relates to the security and authentication methodology. More specifically, the disclosure relates to systems and methods for facilitating authentication utilizing smart devices.

### BACKGROUND

Advancements in Internet technology have enabled easy data access from any location in the world. Oftentimes, however, data restriction may be necessary. For instance, in a banking institution, it may be important to restrict access to personal data only to the authentic user. Similarly, it may be desired to allow access to confidential or sensitive data only to certain employees.

Authorized access to confidential data and protection from unauthorized access, use, and disclosure is of great importance. Often, systems handling restricted data require password authorization to allow access to critical data. Password authorization, however, focuses solely on users; it can be stolen and is unsecure. It is not only difficult to memorize and remember the password but also one cannot completely rely on the data security offered.

Other authentication techniques employ a second authentication mechanism to complement the primary mechanism of using a unique username-password combination. Examples of such techniques are hardware tokens or SMS/App One Time Passwords (OTP). However, the existing solutions suffer from a number of drawbacks ranging from sub-par security, increased cost to poor user experience.

In a HTTP transaction, the basic authentication methods employ a web browser, or other client program, to provide credentials such as a user name and password when making a request. An eavesdropping method such as a keyboard sniffer can compromise such type of authentication. In a certificate based authentication, a client certificate is exchanged to enable the authentication of users. However, access to the client certificate is frequently controlled by a password that is vulnerable to eavesdropping mechanisms.

In a one-time password (OTP) authentication, OTP is only valid for a single login session or transaction. However, OTPs typically require additional hardware such as a security token, presenting additional challenges.

Thus, current solutions do not completely protect the confidentiality, integrity, and availability of information from unauthorized or insecure access. As a result, there exists a need to protect access to data from unsafe, insecure, or unapproved use.

The present invention is robust to many existing security threats such as SMS forwarding, key logging, phishing, transaction altering, and the like. These attacks typically compromise existing authentication methods.

### SUMMARY

One embodiment of the present application describes a method of facilitating authentication. The method includes receiving a request corresponding to a transaction over a first communication channel. Further, the method includes transmitting a challenge to a user device associated with the request over a second communication channel disparate from the first communication channel. Additionally, the method includes receiving a response from the user device comprising an encrypted version of the challenge. The encrypted version is obtained by encrypting the challenge based on a public key. The public key is obtained by decrypting an entity secret stored in the user device based on a passcode provided by the user of the user device. Further, the method includes decrypting the response based on a private key corresponding to the public key to obtain a result. Moreover, the method includes authenticating the user device based on detection of the challenge comprised in the result.

Another embodiment of the application describes an authentication server for facilitating authentication of a user. The authentication server is communicatively coupled to a transaction server configured to receive a request corresponding to a transaction from the user over a first communication channel. The authentication server is communicatively coupled to a user device associated with the user over a second communication channel disparate with the first communication channel. The authentication server includes a processor and a storage communicatively coupled to the processor. The storage is configured to store program code which when executed by the processor causes the authentication server to transmit a challenge to the user device over the second communication channel. The authentication server receives a response from the user device including an encrypted version of the challenge. The encrypted version is obtained by encrypting the challenge based on a public key. The public key is obtained by decrypting an entity secret stored in the user device based on a passcode provided by the user of the user device. Further, the authentication server is configured to decrypt the response based on a private key corresponding to the public key to obtain a result. Based on detection of the challenge comprised in the result, the authentication server authenticates the user.

Certain embodiments of the disclosure may provide various technical advantages. For example, certain implementations may provide greater security than do current data access systems. As embodiments of the claimed invention dynamically restrict access based on user and user device, data is better protected. Further, embodiments of the claimed invention aid adherence to laws and regulations that mandate highly secured access to data (for example, HIPAA, Gramm-Leach-Bliley Act, and the Homeland Security Act) to protect from cyber-attacks. Such acts mandate developing security measures to reliably authenticate customers remotely accessing their Internet-based services.

These and other advantages, features, and objects of the claimed application will become apparent upon review of the following detailed description of the preferred embodiments when taken in conjunction with the drawings and the appended claims.

### BRIEF DESCRIPTION OF DRAWINGS

Exemplary embodiments of the present invention are described hereinafter with reference to the following drawings.

FIG. 1 is a schematic representation of a system that illustrates the method of facilitating authentication of a user.

FIG. 2 is a schematic representation of an authentication server in accordance with an exemplary embodiment.

FIG. 3 is a flow chart illustrating an exemplary method for facilitating authentication.

FIG. 4 shows the MRP (M2FA Registration Phase) stage of M2FA (Mobile Second Factor Authentication)

FIG. 5 shows the post MRP (M2FA Registration Phase) stage of M2FA (Mobile Second Factor Authentication)

FIG. 6 shows the MAP (M2FA Authentication Phase stage of M2FA (Mobile Second Factor Authentication)

FIG. 7 shows the MOP (M2FA OTP Phase) stage of M2FA (Mobile Second Factor Authentication)

While embodiments of the present disclosure are amendable to various modifications and alternative forms, specific embodiments are shown by way of example in the drawings and are described in detail. It should be understood, however, that the drawings and detailed description thereto are not intended to limit the present disclosure to the particular form disclosed, but on the contrary, the intention is to cover all modifications, equivalents, and alternatives falling within the spirit and scope of the present disclosure as defined by the appended claims.

### DETAILED DESCRIPTION

The following detailed description is made with reference to the figures. Embodiments are described to illustrate the disclosed system and method, not to limit their scope.

### Overview

Embodiments of the present application are directed to systems and methods for facilitating authentication of a user for a network transaction.

Embodiments of the present application relate to a method of PIN-based authentication wherein the user's secret PIN is not stored. Attacks on the authentication sever or the user's smart device would not yield the secret PIN, unlike existing solutions that store user's PIN in a central location thereby being vulnerable to attacks and leaks.

The present invention relates to an authentication methodology utilizing smart devices such as smart phones and tablets. The invention provides the user to initiate transaction on a network connection, such as an internet connection, and in response receives a request on her smart device. The user is prompted a PIN number, whereby the transaction is initiated on successful authentication of the PIN entered in the smart device. Upon successful authentication of the PIN, the user is granted with an access to initiate the transaction.

The network connection on which the transaction is initiated is distinct from the network connection via which the smart device received the request, thereby making the authentication out-of-band or on a secondary channel.

The authentication methodology would work only on smart phones and feature phones. Dumb devices, which do not support apps or internet connection, would not support the disclosed methodology.

Further, embodiments of the claimed invention provide addition of a random entity, known as Salt, into the response message originating from the smart phone. Addition of salt into the response message prevents various forms of dictionary attacks.

### Terms and Definitions

Following terms have been described in the application:

### 2FA: Second Factor Authentication

SP: Online Service Provider (e.g. PayPal, Amazon, enterprise VPN, and the like.)
U: A user requesting service from SP. E.g. user logging into PayPal to transfer money. The identity of the user is to be established by SP via 2FA.
M_{U}: A smart user device owned by U.
S_{M2FA}: Authentication server that performs M2FA of user, passing the result of M2FA to SP.
K_{U}: A unique asymmetric public-private key pair generated by S_{M2FA} for user.
K_{PRI,U}: Private key portion of K_{U}; stored in S_{M2FA}.
K_{PUB,U}: Public key portion of K.
P_{U}: PIN/Password selected by user.
h( ): Any existing hashing/key-derivation function.
P_{H}: Digest, result of the operation h(P_{U}).
e(K, P): An encryption operation that encrypts object P with a given key K.
d(K, C): The corresponding decryption operation that decrypts object C with a given key K.
E_{M,U}: Result of the operation e(P_{H}, K_{PUB,U}). We term this ‘entity-secret’.
M_{A}: App/software/program installed on M_{U} which, together with S_{M2FA}, is responsible for completing the M2FA.
Authentication information: Information used for authentication, for example credentials.
Challenge: Private information provided to a user to be used in a response from the user for authenticating the user. Challenge also refers to the prompt to provide the private information response. For example, a user when challenged with a “challenge”, provides a response.
Channel: It is a communications path. It can be a communication path between two applications over a network. For example, a channel can be a TCP/IP connection.
Separate/second channel: a channel other than the primary, or first channel. A second channel is considered out-of-band with respect to a first channel. Separate communication channels may use either common or different physical means of implementation, including, but not limited to two TCI/IP sessions on the same network, two physically separate computer networks, two different types of network (for example, Ethernet and Cellular); and common infrastructures with logical separation (for example, a common Ethernet network with a first and second VLAN implementing the first and second channels).
Out-of-band authentication: It refers to conducting two-factor authentication over a different, separated network or channel than the primary network or channel. For example, using a username and password to complete the primary authentication sent over the Internet (primary network). Whereas, using a different channel to complete the second factor. Approving a push notification sent over your mobile network is an example of out-of-band authentication. If a remote attacker is able to tap into one's computer via Internet connection, they can steal the user's password, and the second form of authentication, if delivered over the same channel.
Salt: A salt is a random number generated during the build process. The salt is stored in the encrypted challenge as a non-accessible string. The salt may be stored as a set of segmented non-printable strings in different parts of the encrypted challenge.

### Exemplary Systems

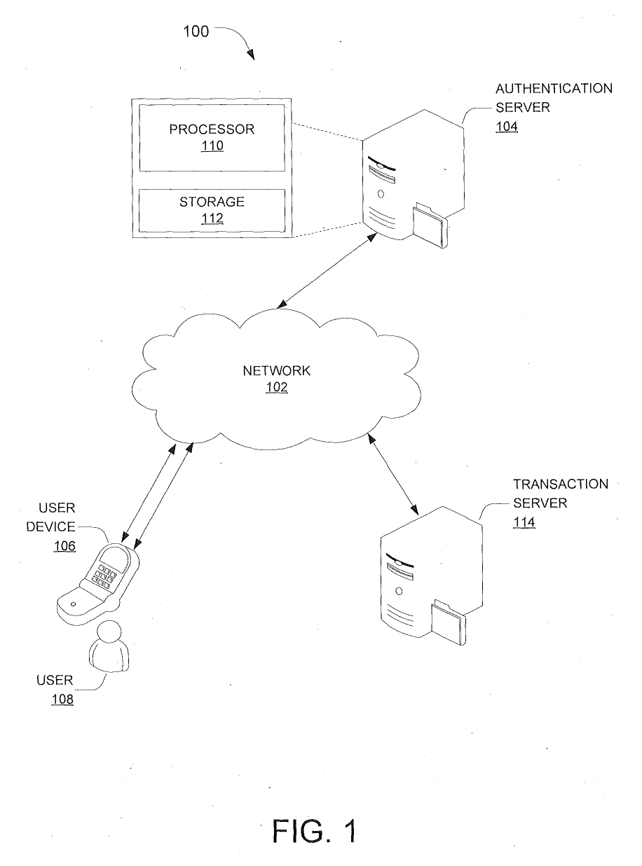

FIG. 1 is a schematic representation of a system 100 that illustrates the method of facilitating authentication of a user. The system 100 generally includes a network 102 communicatively coupling an authentication server 104 to one or more user device 106. Additionally, the network 102 communicatively couples the user device 106 to a transaction server 114. User 108 may be present on user device 106 to generate data requests, provide authorization and authentication information, and receive the requested data.

The user 108 may initiate a service request with the transaction server 114 using any of the one or more user devices 106. The one or more user devices 106 may be registered with the authentication server 104 for Second Factor Authentication. For instance, the user 108 may have two user devices 106, say for example, a smart phone and a personal computer. The user 108 may start the login using the personal computer whereas may complete the Second Factor Authentication using the smart phone. Thus, in this scenario, there are two user devices 106. Service request is initiated from one user device 106, personal computer, but the other user device 106, smart phone, is used for Second Factor Authentication, as the smart phone is registered for 2FA.

In another instance, the user 108 may have a single user device 106, a smart phone. The user 108 may start the login using the smart phone and may complete the Second Factor Authentication using the same smart phone. In this scenario, there is one user device 106. Service request is initiated from the same user device 106 and 2FA is done from the same user device 106.

Similarly, in other instances, the user 108 may have two smart phones and both may be registered for 2FA. Thus, the user may initiate the service request, start login, and authenticate for 2FA using either of the smart phones.

The network 102 generally refers to any interconnecting system capable of transmitting audio, video, signals, data, messages, or any combination of the preceding. Further, the network 102 may include all, or a portions of a public switched telephone network (PSTN), a public or private network, a local area network (LAN), a metropolitan area network (MAN), a wide area network (WAN), a local, regional, or global communication or computer network such as the Internet, a wired or wireless network, an enterprise intranet, other suitable communication link, or any combination of similar systems.

The authentication server 104 may include, for example, a file server, a domain name server, a proxy server, a web server, a computer workstation, or any other device operable to dynamically adjust the access restrictions imposed on the requested data by the system 100 and facilitate authentication to the user 108. Further, the authentication server 104 may use any appropriate operating system, such as MS-DOS®, MAC-OS®, WINDOWS®, UNIX®, including operating systems developed hereafter.

As used here, the term user device 106 generally refers any suitable device operable to communicate with the authentication server 104 and the transaction server 114 through the network 102. Further, the user device 106 may employ any known operating systems such as MS-DOS®, PC-DOS®, OS-2®, MAC-OS®, or any other appropriate operating systems. The user device 106 may include, for example, a personal digital assistant, a computer (e.g., a laptop, a desktop workstation, a server, etc.), a cellular phone, a mobile internet device (MID), an ultra-mobile PC (UMPC), or any other device operable to communicate with the authentication server 104 through the network 102.

The transaction server 114 may be a service provider including a core service provider module for managing interactions with the user 108 through a user interface (UI) and managing interactions with the user device 106 through a mobile access control. The transaction server 114 may execute the requested service, provided by the transaction server 114 by running a service application. The transaction server 114 provides an access control service by verifying the relevant values for authentication and user identification.

The user device 106 includes a user interface for interacting with the UI and the mobile access control of transaction server 114.

Security measures for facilitating authentication of user 108 and providing data access may be performed in the system 100. For example, user 108 may request data from the transaction server 114. In one implementation, user 108 may request access to a web portal from the transaction server 104.

The authentication server 104 includes a processor 110, a storage 112, and a network interface. The network interface connects the authentication server 104 to the network 102 for authenticating user device 106 and servicing data requests made by user 108. The processor 110 may be utilized for processing requirements of the authentication server 104. The storage 112 is further divided into one or more program(s) and data. The data includes various data banks for storing different data. The programs store various program modules designed to dynamically restrict data access and authenticate user 108. The network interface may refer to any suitable device capable of receiving an input, sending an output from the authentication server 104, performing suitable processing of the input or output or both, communicating with other devices, and so on. For example, the network interface may include appropriate hardware modem, network interface card, and similar devices. Further, the software capabilities of the network interface may include protocol conversion and data processing capabilities, to communicate through a LAN, WAN, or other communication system, allowing the authentication server 104 to communicate to other devices. Moreover, the network interface may include one or more ports, conversion software, or both.

The processor 110 can be any suitable device capable of executing instructions and manipulating data to perform operations for the authentication server 104. Processor 110 may include microprocessors, microcomputers, microcontrollers, digital signal processors, central processing units, state machines, logic circuitries, and/or any devices that manipulate signals based on operational instructions. For example, processor 110 may be any central processing unit (CPU), such as such as the Pentium processor, the Intel Centrino processor, and so on.

Further, the storage 112 may be any suitable device capable of storing computer-readable data and instructions. For example, the storage 112 may include logic in the form of software applications, random access memory (RAM) or read only memory (ROM). Further examples may include mass storage medium (e.g., a magnetic drive, a disk drive, or optical disk), removable storage medium (e.g., a Compact Disk (CD), a Digital Video Disk (DVD), or flash memory), a database and/or network storage (e.g., a server), other computer-readable medium, or a combination of any of the preceding.

In operation, the user 108 requests for service from the transaction server 114 by starting the user interface of the user device 106 for accessing a service from the transaction server 114. The user device 106 logins to the transaction server 114. During the login process, the transaction server 114 may authenticate the user 108 based on the user name and password combination.

For providing the Second Factor Authentication, the transaction server 114 requests the authentication server 104 to authenticate the user 108 as a valid user. To this end, the transaction server 114 forwards the unique user identification to the authentication server 104.

In an embodiment, the user device 106 may also transmit the unique user identification to the authentication server 104. The authentication server 104 may verify the unique user identification received from the user device 106 relative to the corresponding unique identification received from the transaction server 114.

The authentication server 104 transmits a challenge to the user device 106 over the second communication channel disparate from the first communication channel over which a request is sent by the user device 106 to the transaction server 114. Thus, an out-of-band challenge is transmitted to the user device 106. As a response, the authentication server 104 receives a response message from the user device 106. The response includes an encrypted version of the challenge transmitted by the authentication server 104 to the user device 106. Based on a passcode provided by the user 108, an entity secret stored in the user device 108 is decrypted to obtain a public key. The passcode may be any combination of input received from the user on one or more input devices comprised in, for example, the user device 106. Based on the public key, the user device 108 encrypts the challenge to obtain the encrypted version of the challenge.

The authentication server 104 decrypts the response based on a private key corresponding to the public key to obtain a result. On obtaining the result, the authentication server 104 authenticates the user 108 based on detection of the challenge comprised in the result.

After the authentication is complete, the authentication server 104 sends an authorization to the transaction server 114. On receiving the authorization, the transaction server 114 requests content for the provided service for the given authorization. Then, the transaction server 114 forwards the content to the user interface of the user device 106.

In an embodiment, the transaction server 114 may include the authentication server 104. Thus, the authentication functions performed by the authentication server 104 are performed by the transaction server 114. The transaction server 114 may include the hardware for performing the functions of the authentication server 104. Alternatively, the transaction server 114 may be communicatively coupled to the authentication server 104 with the transaction server 114 acting as a master and the authentication server 104 acting as a slave.

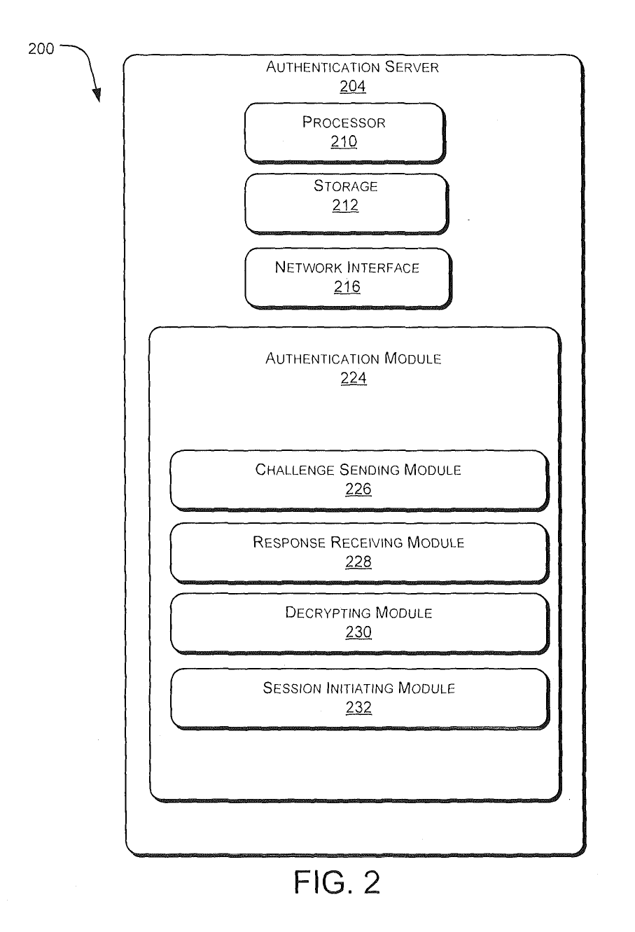

With reference to FIG. 2, the authentication server 104 includes the processor 210, the storage 212, and the network interface 216 for facilitating authentication of user device 106 and user 108. The authentication server 204 may be running an operating system for executing software instructions. In an exemplary embodiment, the authentication server 204 may include an authentication module 224 including a challenge-sending module 226, a response-receiving module 228, a decrypting module 230 and a session-initiating module 232. The challenge-sending module 226 operates to send a challenge to the user device 106 on receiving the request from the transaction server 114 to authenticate the user 108. The response-receiving module 228 operates to receive response for the challenge for user identification from the user device 106. The response includes an encrypted version of the challenge transmitted by the authentication server 204 to the user device 106. Based on a passcode provided by the user 108, an entity secret stored in the user device 106 is decrypted to obtain a public key. Based on the public key, the user device 106 encrypts the challenge to obtain the encrypted version of the challenge. The decrypting module 230 operates to decrypt the response based on a private key corresponding to the public key to obtain a result.

The authentication module 224 authenticates the user device 106 based on detection of the challenge comprised in the result. The session-initiating module 232 operates to inform the transaction server 114 that the user 108 was successfully authenticated via the user device 106. After receiving the authentication, the transaction server 114 is notified to grant access to the user 108 for performing the transaction. If the authentication result is negative, the authentication server 104 informs the transaction server 114 that the authentication result is negative. Thus, the authentication result is communicated to the transaction server 114. The transaction server 114 may allow or deny access to the user 108 for performing the transaction as it may deem appropriate.

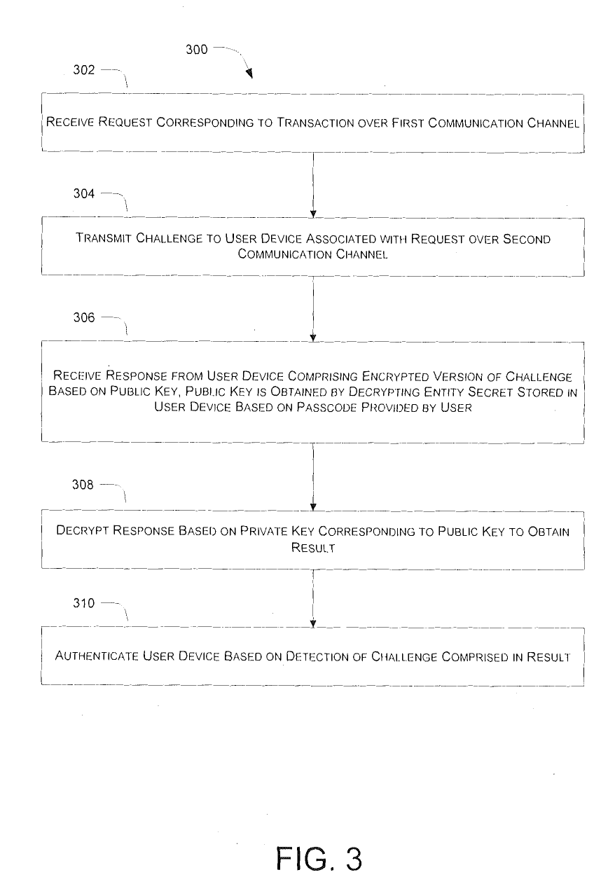

FIG. 3 illustrates exemplary method 300 for facilitating authentication to the user 108. The exemplary method is described with reference to the system 100 and the authentication server 104 introduced in FIG. 1. These exemplary methods may be described in the general context of computer executable instructions. Generally, computer executable instructions can include routines, programs, objects, and the like that perform particular functions or implement particular abstract data types. The methods may also be practiced in a distributed computing environment where functions are performed by remote processing devices that are linked through a communications network. In a distributed computing environment, computer executable instructions may be located in both local and remote computer storage media, including memory storage devices.

In FIG. 3, the process begins at step 302, where the authentication server 104 receives a request corresponding to a transaction; here, the user 108 may require access to data stored on transaction server 114 for performing a transaction. To this end, the user 108 may use the user device 106 to send a transaction data request to the transaction server 114. The transaction server 114 forwards the request to authentication server 104 for authenticating the user 108.

Moving to the step 304, the authentication server 104 transmits a challenge to user device 106 associated with the request. The challenge is transmitted over a second communication channel disparate from the first communication channel.

At step 306, the authentication server 104 receives a response from the user device 106. The response includes an encrypted version of the challenge transmitted by the authentication server 104 to the user device 106. Based on a passcode provided by the user 108, an entity secret stored in the user device 106 is decrypted to obtain a public key. Based on the public key, the user device 106 encrypts the challenge to obtain the encrypted version of the challenge.

The method 300 continues to step 308 where the authentication server 104 decrypts the response based on a private key corresponding to the public key to obtain a result.

At step 310, the authentication server 104 authenticates the user device 106 based on detection of the challenge comprised in the result. If the user device 106 is determined as authenticated, the transaction server 114 is notified to grant access to the user 108 for performing the transaction. If the authentication result is negative, the authentication server 104 informs the transaction server 114 that the user 108 could not be authenticated. Thus, the authentication result is communicated to the transaction server 114 corresponding to the user 108 for performing the transaction. The transaction server 114 may allow or deny access to the user 108 for performing the transaction as it may deem appropriate.

In an embodiment, the user device 106 may generate the response including an encrypted version of each of the challenge and a randomly generated string. Addition of the randomly generated string, known as Salt, into the response originating from the smart phone prevents various forms of dictionary attacks. In an exemplary embodiment, the user device 106 may generate a response including an encrypted version of the challenge concatenated with the randomly generated string. In another embodiment, the user device 106 may delete the passcode provided by the user 108 from the user device subsequent to decrypting the entity secret.

In another embodiment, the user device 106 may decrypt the entity secret based on a hash of the passcode provided by the user 108. In an exemplary embodiment, the user device 106 may delete the hash of the passcode from the user device 106 subsequent to decrypting the entity secret.

In another embodiment, the user device 106 may delete the public key from the user device 106 subsequent to generation of the response.

In another embodiment, the authentication server 104 may identify at least one user device 106 from a plurality of user devices associated with the request. In an exemplary embodiment, the authentication server 104 may receive a selection of the user device 106 from the plurality of user devices.

In another embodiment, the authentication server 104 may transmit a challenge including a random string to the user device 106 associated with the request.

In yet another embodiment, the authentication server 104 may register an association of the user device 106 with the user 108. The transaction server 114 transmits each of a user credential and a service provider credential associated with the transaction to the authentication server 104. The authentication server further transmits each of the user credential and the service provider credential associated with the transaction to the user device 106. On receiving the registration data, the user device 106 presents the registration data to the user 108. Based on the registration data, the user 108 approves the registration for transmission to the authentication server 104. The authentication server 104 receives the registration message from the user device 106 and transmits a request to the user device 106 to provide the passcode. On receiving the passcode from the user 108, the user device 106 computes an entity secret based on each of the public key and the passcode. The entity secret is stored in a storage of the user device 106.

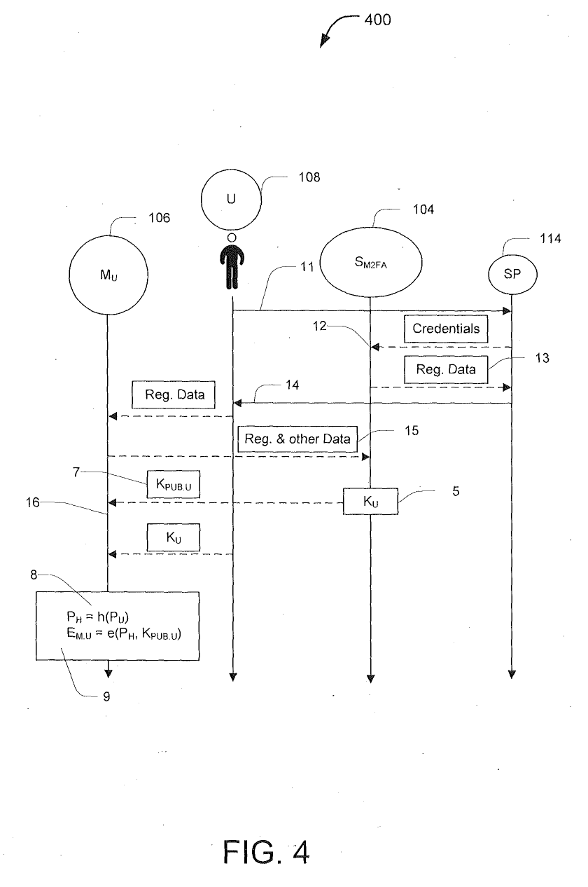

With reference to FIG. 4, the first phase of Mobile Second Factor Authentication (M2FA) is registration, during which the user 108 registers the user device 106 with S_{M2FA} for service provided by the service provider.

FIG. 4 shows the MRP stage of M2FA. The user 108 connects to the SP 114 (11). This connection can be the typical log-in process wherein the user 108 enters username/password and logs into the SP 114. Other techniques of authentication as employed by the SP 114 are also possible. The user 108 proceeds to register a smart user device 106 as a second factor authentication device. This procedure occurs as a result of SP 114 prompting the user 108 to do the registration or due to the user's own initiative. The registration process can be triggered via clicking on a link or any other method as employed by the SP 114. The SP 114 transmits credentials of the user 108 to S_{M2FA} 104 (12). Credentials may include user 108 username, email or the like. Additionally, SP 114 credentials such as name, etc. may also be transmitted. S_{M2FA} 104 stores the incoming credentials and returns registration data (13). This data could be a code, a series of strings, or the like. The registration data is then displayed to the user 108 by SP 114 (14) The display could be in the form of QR codes, text boxes, or strings. The user 108 launches M_{A} on user device 106. The registration data is then fed into user device 106. This can be achieved via a QR code scanner, manual entry or any other form of data entry. M_{A} transmits the fed data, along with other data such as push id, device name, data entered by user in response to prompt(s) by M_{A} etc., to S_{M2FA} 104 (15). S_{M2FA} 104 generates K_{U} and transmits K_{PUB,U} to user device 106 along with other relevant data, while storing K_{PRI,U} and the data received from the user device 106. M_{A} prompts the user 108 to set a PIN number P_{U} (16). This PIN could be a combination of numbers, characters, symbols, or the like. The user 108 sets P_{U} of choice via a keypad or any suitable input method. Now, entity-secret E_{M,U} is computed by M_{A}. E_{M,U} is stored in the user device 106 along with any relevant data from S_{M2FA} 104. Thus, the registration stage MRP is completed. The user device 106 may also store other data received from S_{M2FA} 104 (17). S_{M2FA} 104 may also store other data received from SP 114 and user device 106 (18).

Further, MRP is a one-time process. At the end of MRP, an entity-secret E_{M,U}, is obtained and stored within user device 106. K_{PRI,U} is stored in S_{M2FA} 104. Intermediates, such as K_{PUB,U}, P_{H} etc. are discarded.

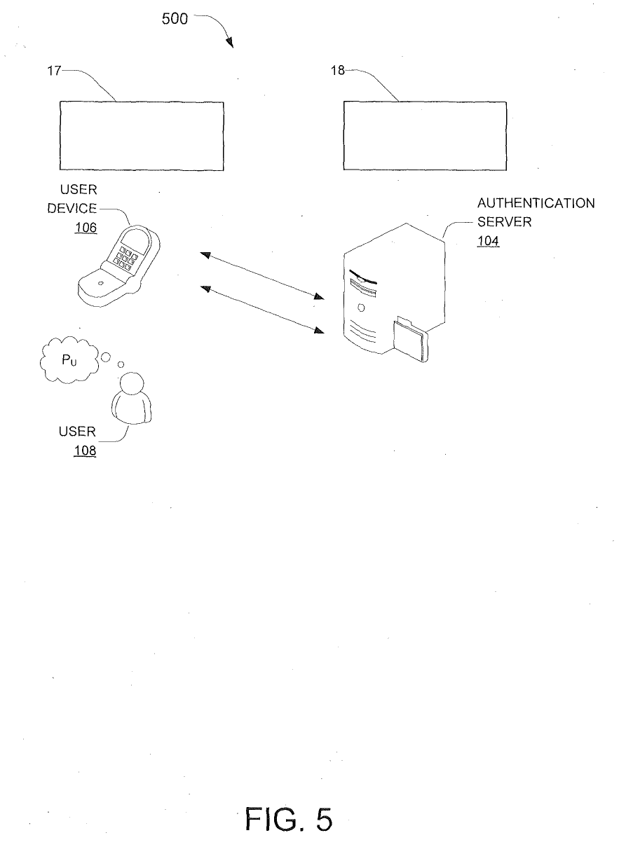

FIG. 5 illustrates the post MRP state of user device 106, user 108 and S_{M2FA} 104. MRP can be done multiple times by user 108, using the same user device 106 or multiple user device 106, for each SP 114 that user 108 can derive service from. For each such registration, the MRP process is carried out. User 108 can now be authenticated via user device 106 on behalf of an SP 114 that might request such an authentication. We now describe this authentication methodology, which is the second phase of M2FA.

In another embodiment of MRP, user 108 is not prompted for P_{U}, and then the process of setting Pin Number is skipped wherein the said process includes:

a) M_{A} prompts user 108 to set a PIN number P_{U} having PIN as a combination of numbers, characters, or symbols.
b) User 108 sets P_{U} of choice through keypad or any suitable input method
c) M_{A} computes the Entity-secret (E_{M,U}) and E_{M,U} is stored in the user device 106 along with any relevant data from S_{M2FA} 104. The process of setting Pin Number is skipped, and K_{PUB,U} is stored by M_{A}.

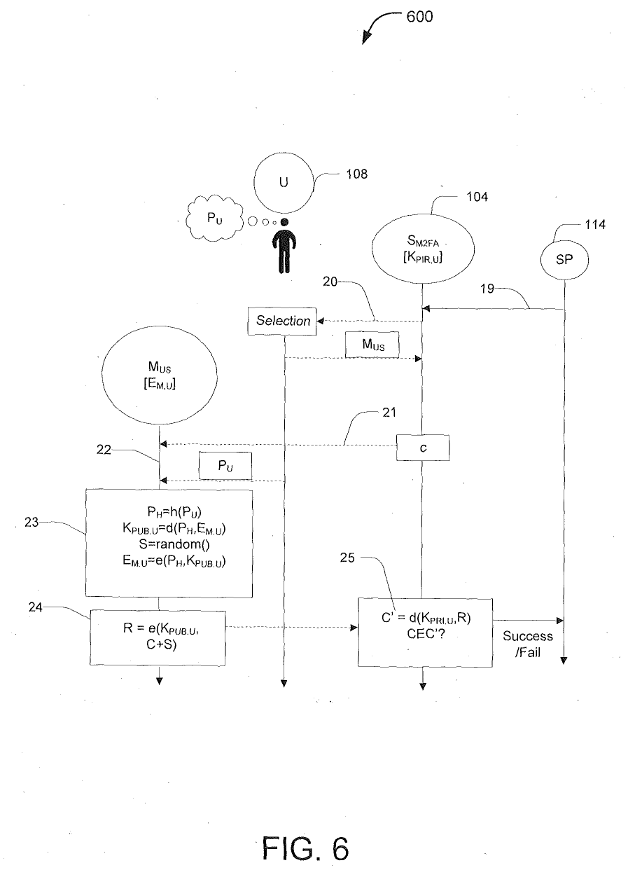

FIG. 6 illustrates the MAP stage of M_{2FA}. As illustrated in FIG. 6, S_{M2FA} 104 receives an authentication request from an SP 114 to authenticate a user 108 (19). The request can contain user 108 credentials like username, email etc., along with SP 114 credentials like name etc. If multiple user device 106 are registered under user 108 for the request from SP 114 (20), a device list choice is generated by S_{M2FA} 104. This method can be a complete or partial list of smart user devices 106 registered under user 108 for the request from SP 114. This list can be in form of a drop-down box or any other form of entry selection. This list could also be generated even if only one user device 106 is registered under user 108. User 108 is prompted to select a device from the above list which is user device 106, wherein the selection is transmitted to S_{M2FA} 104.

In another embodiment, S_{M2FA} 104 can select a user device 106 on behalf of user 108 without prompting user 108 to make a selection. S_{M2FA} 104 generates a random string, also known as challenge C, and transmits C to user device 106 (21). M_{A} on user device 106 receives C (22) wherein M_{A} prompts user 108 to enter P_{U}. M_{A} computes P_{H}=h (P_{U}) and K_{PUB,U}=d(P_{H}, E_{M,U}) (23) whereby a random salt S is generated.

M_{A} generates response R=e(K_{PUB,U}, C+S) (24). [‘+’ denotes any concatenation operation] The response is transmitted to S_{M2FA} 104 which receives C′=d(K_{PRI,U}, R) (25). Therefore, if C is within C′, user 108 is successfully authenticated. The user 108 is not authenticated if C is not within C′. The result of the authentication is transmitted to SP 114 by S_{M2FA} 104. SP 114 can now take any pertinent action depending on the authentication result. This action could include allowing/denying log-in for user 108, transferring data to the user device 106, or the like. Intermediates generated by M_{A}, such as P_{U}, K_{PUB,U}, P_{H} etc. are discarded.

In another embodiment of MAP, corresponding to the MRP version that does not prompt for P_{U}, user 108 is not prompted for P_{U}, and process of M_{A} prompting user 108 to enter P_{U} and computing P_{H}=h (P_{U}) and K_{PUB,U}=d(P_{H}, E_{M,U}) are skipped. Instead, M_{A} prompts user 108 for input. The rest of the method continues as per before after M_{A} receives input from user 108. This input could be via any user interface element such as a button, touch screen input, or the like.

In yet another embodiment of MAP, M_{A} could also provide user 108 with various other input options/prompts in addition to or in exclusion to P_{U} prompt. In an exemplary embodiment, M_{A} displays one or more UI element(s) UIE to user 108. When and if user 108 selects UIE(s), a message is transmitted from M_{A} to SP 114 indicating to SP 114 the selected UIE(s). The content of the message could be any string of data. SP 114 could take any pertinent action depending upon the received string of data, including locking/disabling user 108 account.

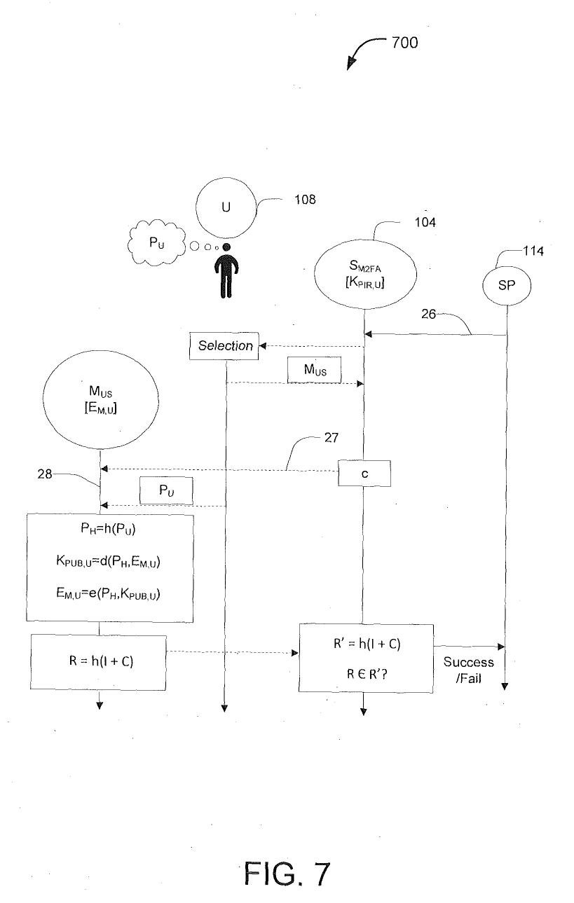

FIG. 7 illustrates the M2FAOTP Phase (MOP). In an embodiment, the smart user device 106 of the user 108 is assumed to possess no network connectivity at the time of authentication, wherein the smart user device 106 does not have any communication channel via which communication between the user device 106 and the authentication server 104 can occur. That is, the user device 106 M_{U} of user 108 has no network connectivity via which it can communicate with S_{M2FA} 104. In this embodiment, authentication occurs via MOP.

As illustrated in FIG. 7, S_{M2FA} 104 receives an authentication request from an SP 114 (26) to authenticate a user 108. The request could contain user 108 credentials like username, email etc., along with SP 114 credentials like name etc. If multiple user device 106 are registered under user 108 for the request from SP 114, a device list choice is generated by S_{M2FA} 104. This can be a complete or partial list of smart user devices 106 registered under user 108 for the request from SP 114. This list can be in form of a drop-down box or any other form of entry selection. This list could also be generated even if only one user device 106 is registered under user 108. User 108 is prompted to select a device from the above list which is user device 106 M_{US}, User 108 selection is transmitted to S_{M2FA} 104. Further, S_{M2FA} 104 generates a random string, also known as challenge C (27) which is displayed to user 108 who enters C into M_{A} on user device 106 M_{US} (28).

User 108 enters C into M_{A}, the entry method can be via QR code, manual entry or any other means. Upon receiving C, M_{A} prompts user 108 to enter P_{U} and thereby M_{A} computes P_{H}=h(P_{U}) and K_{PUB,U}=d(P_{H}, E_{M,U}). M_{A} generates response R=h(I+C), where I is an operand derived from K_{PUB,U} via any suitable operation (such as (public exponent of K_{PUB,U})+(modulus of K_{PUB,U})) [+ indicating a concatenation]. The response R, either in full or in partial, is displayed to user 108 and user 108 is prompted to feed R to S_{M2FA} 104. This can be done manually by user 108. S_{M2FA} 104 obtains R′=h (I+C), where I is the same operand. If R equals R′, user 108 is successfully authenticated or if otherwise, user 108 is not authenticated. The result of the authentication is transmitted to SP 114 by S_{M2FA} 104. Now, SP 114 can take any pertinent action depending on the authentication result. This action can include allowing/denying log-in for user 108, transferring data to the user device 106, or the like.

Intermediates generated by M_{A}, such as P_{U}, K_{PUB,U}, P_{H} etc. are discarded. In another embodiment of the MOP, corresponding to the MRP version that does not prompt for P_{U}, there is no P_{U}. The mobile application M_{A} rejects prompting user 108 to enter P_{U}, thereby further rejecting M_{A} to compute P_{H}=h(P_{U}) and K_{PUB,U}=d(P_{H}, E_{M,U}).

In another embodiment of MOP, S_{M2FA} 104 does not provide user 108 with a choice of devices. S_{M2FA} 104 receives an authentication request from an SP 114 to authenticate the user 108. The request could contain user 108 credentials such as username, email, and the like, along with SP 114 credentials such as name, and the like. S_{M2FA} 104 generates a random string, also known as challenge C. C is displayed to user 108 and user 108 is prompted to enter C into M_{A} on any registered user device 106. User 108 enters C into M_{A} of a registered user device 106; the entry method could be via QR code, manual entry or any other means. Upon receiving C, M_{A} prompts user 108 to enter P_{U} thereby M_{A} computes P_{H}=h(P_{U}) and K_{PUB,U}=d(P_{H}, E_{M,U}). M_{A} generates response R=h (I+C), where I is an operand derived from K_{PUB,U} via any suitable operation such as (public exponent of K_{PUB,U}) (modulus of K_{PUB,U})) indicating a concatenation). The response R, either in full or in partial, is displayed to user 108 and user 108 is prompted to feed R to S_{M2FA} 104. This could be done manually by user 108. Having been fed R, S_{M2FA} 104 obtains a set {R′}=h({I}+C), where {I} is a set of operands derived, for every user device 106 registered under user 108. If R C {R′}, user 108 is successfully authenticated, if otherwise, user 108 is not authenticated. The result of the authentication is transmitted to SP 114 by S_{M2FA} 104. SP 114 can now take any pertinent action depending on the authentication result. This action could include allowing/denying log-in for user 108, and the like. Intermediates generated by M_{A}, such as P_{U}, K_{PUB,U}, P_{H} etc. are discarded. In another embodiment of the MOP stage, corresponding to the MRP version that does not prompt for P_{U}, there is no P_{U}. The mobile application M_{A} rejects prompting user 108 to enter P_{U}, thereby further rejecting M_{A} to compute P_{H}=h(P_{U}) and K_{PUB,U}=d(P_{H}, E_{M,U}).

It will be appreciated that various above-disclosed embodiments, other features and functions, or alternatives thereof, may be desirably combined into many other different systems or applications. Various presently unforeseen or unanticipated alternatives, modifications, variations, or improvements therein may be subsequently made by those skilled in the art which are also intended to be encompassed by the following claims.

1. A method of facilitating authentication, the method comprising:
a. receiving a request corresponding to a transaction, wherein the request is received over a first communication channel;
b. transmitting a challenge to at least one user device associated with the request, wherein the challenge is transmitted over a second communication channel disparate from the first communication channel;
c. receiving a response from at least one of the user, and the at least one user device, wherein the response comprises an encrypted version of at least the challenge, wherein the encrypted version is obtained by encrypting the challenge based on a public key, wherein the public key is obtained by decrypting an entity secret stored in the at least one user device based on a passcode provided by a user of the at least one user device;
d. decrypting the response based on a private key corresponding to the public key to obtain a result; and
e. authenticating the at least one user device based on detection of the challenge comprised in the result.

2. The method of claim 1, wherein the response comprises an encrypted version of each of the challenge and a randomly generated string.

3. The method of claim 2, wherein the response comprises an encrypted version of the challenge concatenated with the randomly generated string.

4. The method of claim 1, wherein the passcode provided by the user is deleted from the at least one user device subsequent to decrypting the entity secret.

5. The method of claim 1, wherein decrypting the entity secret is based on a hash of the passcode.

6. The method of claim 5, wherein the hash of the passcode is deleted from the at least one user device subsequent to decrypting the entity secret.

7. The method of claim 1, wherein the public key is deleted from the at least one user device subsequent to generation of the response.

8. The method of claim 1 further comprising identifying the at least one user device from a plurality of user devices associated with the request.

9. The method of claim 1 further comprising receiving a selection of the at least one user device from the plurality of user devices.

10. The method of claim 1, wherein the challenge comprises a random string.

11. The method of claim 1 further comprising registering an association of the at least one user device with the user.

12. The method of claim 11, wherein the registering comprises:
a. transmitting each of a user credential and a service provider credential associated with the transaction, wherein the transmission is performed from a transaction server to the authentication server;
b. receiving a registration data from the authentication server;
c. presenting the registration data to the user, wherein the presenting is performed on the at least one user device;
d. receiving a registration message from the at least one user device, wherein the registration message is based on the registration data;
e. transmitting a request to provide the passcode, wherein the request is transmitted to the at least one user device;
f. receiving the passcode from the at least one user device;
g. computing an entity secret based on each of the public key and the passcode; and
h. storing the entity secret in a storage comprised in the at least one user device.

13. An authentication server for facilitating authentication of a user, wherein the authentication server is communicatively coupled to a transaction server, wherein the transaction server is configured to receive a request corresponding to a transaction from the user over a first communication channel, wherein the authentication server is communicatively coupled to at least one user device associated with the user over a second communication channel disparate with the first communication channel, wherein the authentication server comprises a processor and a storage communicatively coupled to the processor, wherein the storage is configured to store program code which when executed by the processor causes the authentication server to:
a. transmit a challenge to the at least one user device, wherein the challenge is transmitted over the second communication channel;
b. receiving a response from at least one of the user and the at least one user device, wherein the response comprises an encrypted version of at least the challenge, wherein the encrypted version is obtained by encrypting the challenge based on a public key, wherein the public key is obtained by decrypting an entity secret stored in the at least one user device based on a passcode provided by the user of the at least one user device;
c. decrypting the response based on a private key corresponding to the public key to obtain a result; and
d. authenticating the user based on detection of the challenge comprised in the result.

14. The authentication server of claim 13, wherein the response comprises an encrypted version of each of the challenge and a randomly generated string.

15. The authentication server of claim 14, wherein the response comprises an encrypted version of the challenge concatenated with the randomly generated string.

16. The authentication server of claim 13, wherein the passcode provided by the user is deleted from the at least one user device subsequent to decrypting the entity secret.

17. The authentication server of claim 13, wherein decrypting the entity secret is based on a hash of the passcode.

18. The authentication server of claim 13, wherein the hash of the passcode is deleted from the at least one user device subsequent to decrypting the entity secret.

19. The authentication server of claim 13, wherein the public key is deleted from the at least one user device subsequent to generation of the response.

20. The authentication server of claim 13, wherein the program code comprises further instructions for registering an association of the at least one user device with the user.
